(19) United States
(12) Patent Application Publication
(10) Pub. No.: US 2002/0061365 A1
(43) Pub. Date: May 23, 2002

(54) AQUEOUS EMULSIONS, A PROCESS FOR THE PREPARATION AND THE USE THEREOF

(76) Inventors: WOLFGANG GRAPE, KOLN (DE); RUDI STRACKE, KOLN (DE); FRANK ZILLMER, LEVERKUSEN (DE); ARMAND DE MONTIGNY, LEVERKUSEN (DE)

Correspondence Address: WILLIAM C. GERSTENZANG, NORRIS, MCLAUGHLIN & MARCUS, P.A., 220 EAST 42ND STREET-30TH FLOOR, NEW YORK, NY, 10017, US

(21) Appl. No.: 08/890,654

(22) Filed: Jul. 9, 1997

(30) Foreign Application Priority Data
Jul. 15, 1996 (DE) 19628447.3

(51) Int. Cl. C08G 77/06

(52) U.S. Cl. 427/387; 524/837; 524/767; 524/714; 524/777; 524/736; 524/759; 524/773; 524/803; 524/730; 524/731; 428/447

(57) ABSTRACT

The invention relates to aqueous emulsions, a process for the preparation and the use thereof.

Organopolysiloxane preparations cross-linking by hydrosilylation reactions have long been used as emulsions for e.g. release coatings for flexible materials (U.S. Pat. No. 3,527,659). Such cross-linking systems generally comprise:

at least one organopolysiloxane with at least two unsaturated hydrocarbon groups in the molecule,

at least one organohydrogen polysiloxane with at least three SiH groups in the molecule, and

a quantity of a metal compound from the platinum group sufficient for a catalytic effect.

Moreover, two-component emulsion systems are used for the preparation of release coatings which, according to U.S. Pat. No. 3,900,617, are composed of a 40% emulsion of a dimethylpolysiloxane polymer with dimethylvinylsiloxy end groups, a Pt catalyst, emulsifiers in water and a 40% emulsion of a methyl hydrogen polysiloxane.

Said emulsion systems still have an unsatisfactory release performance, however.

The problem of storage stability which occurs with many emulsions was solved in U.S. Pat. No. 5,500,148 by the fact that the pH of the emulsion is adjusted to 3 to 5 by means of an organic or inorganic acid. Here, too, however, it is still necessary to add the Pt catalyst to the mixture of the other components immediately before the emulsion is used in order to ensure that the curing reaction takes place.

Now as ever, a difficulty with the preparation of release coatings is that of obtaining the suitable pot lives, i.e. the residence times of the substrates to be coated in the bath containing the silicone coating and guaranteeing rapid curing in the drying oven. Gel particles, i.e. cured silicone particles, often form in the oven itself with the emulsions known hitherto for the release coating. This phenomenon, known as dusting, reduces the yield of silicone applied to the substrate and requires an immense amount of cleaning from time to time in the region of the drying oven and its surroundings. Another disadvantage of the emulsions known from the prior art is that of intense foaming, which is a troublesome feature during processing.

The object of the present invention was, therefore, to provide aqueous emulsions which are suitable for the preparation of an abhesive (release) finish for flexible substrates, particularly as a release coating, and which do not exhibit the disadvantages known in the prior art.

Surprisingly, it has now been found that aqueous emulsions which contain addition-cross-linking polydiorganosiloxanes and small quantities of unreactive organopolysiloxane in addition to the known constituents are easy to prepare and stable in storage, in which dusting may be very largely avoided in high-quality coatings and in which foaming may also be very largely suppressed.

The invention therefore provides aqueous emulsions consisting essentially of:

at least one organopolysiloxane A) containing at least 2 unsaturated hydrocarbon groups,

at least one methyl hydrogen polysiloxane B),

at least one unreactive organopolysiloxane C),

at least one catalyst D) from the platinum group,

at least one inhibitor E),

optionally, emulsifiers and/or thickeners F), and

optionally, additives and/or auxiliary substances G).

The organopolysiloxane A) within the meaning of the invention containing at least 2 unsaturated hydrocarbon groups is preferably a cyclic, linear or branched polysiloxane which has units corresponding to the general formula

(R)ₐ(R¹)_{b}SiO_{(4-a-b)/2} (I)

where R=a C₂-C₈-alkenyl [and/]or unsaturated C₃-C₁₀-ether radical, such as, e.g. vinyl, allyl, 1-butenyl, 1-hexenyl or —CH₂—CH₂CH₂OCH₂CH═CH₂ etc.,

R¹=monovalent, saturated, optionally substituted hydrocarbon radicals with up to 10 carbon atoms from the group consisting of substituted and unsubstituted alkyl, aryl and arylalkyl radicals, wherein a and b are integers within the following limits: 0≦a ≦3 or 0≦b≦3 and 0≦a+b≦4 and each individual R or R¹ within the molecule may be the same or different than any other R or R¹ within the molecule.

R is preferably vinyl or allyl, and particularly preferably vinyl.

Examples of R¹ are methyl, ethyl, propyl, isopropyl, butyl, octyl etc., cyclobutyl, cyclopentyl, cyclohexyl etc., phenyl, tolyl, xylyl, naphthyl etc., benzyl, phenylethyl, phenylpropyl. In one embodiment of the invention, some or all of the hydrogen atoms of alkyl, aryl and arylalkyl radicals R¹ are substituted by fluorine and/or chlorine, bromine or iodine atoms and/or cyano radicals. In this case, R¹ corresponds, for example, to chloromethyl, trifluoropropyl, chlorophenyl, dibromophenyl, β-cyanoethyl, β-cyanopropyl or γ-cyanopropyl radicals. In preference, however, at least 90% of the radicals R¹ are methyl.

In a preferred embodiment of the invention, a equals 0 or 1.

Using nomenclature familiar to the expert, namely

| | |
|---|---|
| M | = (CH₃)₃SiO_{1/2}, |
| D | = (CH₃)₂SiO_{2/2}, |
| T | = (CH₃)SiO_{3/2}, |
| Q | = SiO_{4/2}, while T and Q are branching sites |
| M^{Vi} | = (CH₂═CH)(CH₃)₂SiO_{1/2} and |
| D^{Vi} | = (CH₂═CH)(CH₃)SiO_{2/2} the following examples may be given |
| | for the component A): |

M₂D₁₀₀D^{Vi}₃, M^{Vi}₂D₁₈₀, M^{Vi}MD₁₀₀D^{Vi}₃, T₅D₅₅₀M^{Vi}₇, T₃D₅₀₀M^{Vi}₂M₃ and/or T₆D₃₀₀D^{Vi}M₄M^{Vi}₄.

In component A), between 0.05 and 10% of R are unsaturated, particularly preferably between 0.2 and 6% and more particularly preferably 0.6 to 2% of component A). The viscosity of component A) is preferably between 10 and 100000 mPas, particularly preferably 50-10 000 mPas, at 25° C.

In a preferred embodiment of the invention, the component A) is a branched organopolysiloxanes wherein the ratio of the number of diorganosiloxy units (D units) to the number of branching sites is on average 15 and 40, therein at least one triorganosiloxy unit (M unit) and at most half of all the M units are free from unsaturated radicals, the remaining M units each bear only one unsaturated radical, and the content of unsaturated radicals is 0.1 to 1 mmol/g (0.6 to 2%).

The branching sites of component A) are preferably monoorganosiloxy units, i.e. trifunctional siloxy units (T units), which may, however, also be replaced in some cases by tetrafunctional siloxy units (SiO_{4/2} units, Q units). Those organopolysiloxanes are e.g. described in DE-A 43 28 652.

The end groups of the branched organopolysiloxane free from unsaturated radicals have the function of an internal plasticiser. The flexibility of the cross-linked film may be controlled by means of the number of end groups free from unsaturated radicals (M units).

Examples of the preferred component A) are compounds corresponding to the formulae

T₅D₂₀₀M^{Vi}₅M₂, T₇D₂₈₀M^{Vi}₅M₄,

T₆D₁₈₀D^{Vi}₂M^{Vi}₄M₄ and/or T₈D₂₅₀M^{Vi}₇M₃.

Branched organopolysiloxanes A) containing at least 2 unsaturated hydrocarbon groups may be prepared by conventional methods, such as e.g. by hydrolysis of chlorosilanes followed by polymerisation with low molecular weight cyclic diorganopolysiloxanes.

The methyl hydrogen polysiloxane B) contains preferably units corresponding to the general formula

H_{c}(R²)_{d}SiO_{(4-c-d)/2} (II)

wherein R²=monovalent, saturated, optionally substituted hydrocarbon radicals with up to 10 carbon atoms from the group consisting of substituted and unsubstituted alkyl, phenyl, phenylalkyl and/or C₂-C₈ alkenyl radicals, wherein

c and d are integers with 0≦d≦3 and 0≦c≦2 and 0≦c+d≦4, preferably 0≦c≦1.

The methyl hydrogen polysiloxanes B) are preferably linear. At least half of the D units have hydrogen atoms bound preferably directly to silicon (H(CH₃)SiO groups). The number of groups containing hydrogen atoms bound directly to silicon is preferably between 70 and 85% of the bifunctional units.

The molar proportion of hydrogen atoms bound directly to a silicon atom in component B) may be chosen at will—within the context of the structural limitations mentioned above.

In component B), the molar proportion of hydrogen atoms bound directly to a silicon atom is preferably between 0.01 and 17 mmol, particularly preferably between 0.1 and 17 mmol and very particularly preferably between 1 and 17 mmol per gram of component B). This means that preferably between 3 and 50% of the residues R and H, more preferred 30 to 50%.

Examples of component B) are compounds corresponding to the formulae

M^{H}₂D₁₀, M₂D₁₀D^{H}₁₀, M^{H}₂D^{H}₂₀D₁₀,

M^{Vi}₂D^{H}₁₁ and/or M₂D^{Vi}₃D^{H}₈ where

M^{H}=H(CH₃)₂SiO_{1/2} and

D^{H}=H(CH₃)SiO_{2/2}.

The components A) and B) lie preferably in a quantity ratio such that the molar ratio of hydrogen atoms bound directly to a silicon atom (SiH) in component B) to the unsaturated radicals (Si-vinyl) in component A) is between 0.05 and 20, particularly preferably between 0.5 and 10 and very particularly preferably between 1 and 3.

The organopolysiloxane C) within the meaning of the present invention is preferably a polysiloxane containing units corresponding to the general formula

(R¹)ₑSiO_{(4-e)/2} (III)

wherein R¹ are monovalent, saturated, optionally substituted hydrocarbon radicals with up to 10 carbon atoms selected from the group consisting of substituted and unsubstituted alkyl, phenyl and arylalkyl radicals, which may be the same or different within the molecule, and e may be integers between 0 and 3.

Component C) is preferably a linear polydimethylsiloxane end-capped with trimethylsiloxy groups. The use of such trimethylsiloxy end-capped polydimethylsiloxane with a viscosity of between 50 mm₂s⁻¹ and 5000 mm²s⁻¹ is particularly preferred.

The catalyst from the platinum group (D) contains preferably the elements platinum, rhodium, iridium, nickel, ruthenium and/or palladium in the elemental form, on a support substance or in the form of its compounds. Platinum compounds or platinum complexes are preferred, such as for example H₂PtCl₆, platinum-olefin complexes, platinum-alcohol complexes, platinum-vinylsiloxane complexes or elemental platinum on a support substance such as, e.g. activated carbon, Al₂O₃ or SiO₂. Component D) is particularly preferably a platinum-vinylsiloxane complex. Said platinum-vinylsiloxane complexes then preferably have at least 2 olefinically unsaturated double bonds in the siloxane. These are described e.g. in U.S. Pat. No. 3,715,334.

The term siloxane in this context includes polysiloxanes, i.e. for example vinylpolysiloxanes.

The proportion of component D), based on the sum of all the constituents, is preferably between 1 and 1000 ppm, particularly preferably between 1 and 500 ppm and very particularly preferably between 25 and 250 ppm.

The catalyst from the platinum group D) may also be dissolved beforehand, for example, in a part of the polymer A).

The term inhibitor E) within the meaning of the invention includes all the inhibitors known from the prior art, to prevent that reaction occurs at room temperature when mixing components together and making sure a certain pot-life such as e.g. maleic acid and derivatives thereof, amines, alkylisocyanurates and acetylenically unsaturated alcohols, in which the OH group is bound to a carbon atom adjacent to the C—C triple bond, as described in more detail e.g. in U.S. Pat. No. 3,445,420. Component E) is preferably 2-methyl-3-butyn-2-ol, 1-ethynylcyclohexanol and/or (±) 3-phenyl-1-butyn-3-ol. The quantity of component E) in the mixture is preferably 0.0001% to 5%, particularly preferably 0.01% to 2% and very particularly preferably 0.1 to 1%, based on the total weight of the mixture.

In principle, component F) includes all the emulsifiers and/or thickeners suitable for the formation and stabilisation of emulsions (compare e.g. McCutcheon's Detergents & Emulsifiers, International Edition).

In the event that the emulsions according to the invention are used for the preparation of release coatings in the food sector, preferred emulsifiers are those that are mentioned in the FDA Regulations 176.170 “Components of Paper and Paperboard”.

Examples of suitable emulsifiers and thickeners F) are:

C₈-C₂₂-alkyldimethylbenzylammonium chloride, preferably at most 1.5%, sodium lauryl sulphate, preferably at most 0.5%, polyethylene glycol ethers of monohydric aliphatic alcohols C₁₂-C₂₀ and C₂-C₉ alkyl phenols, polyethylene glycol esters of natural fatty acids C₈-C₂₂ and vegetable oils, and/or partially acetylated polyvinyl alcohol with less than 20% acetyl groups and a K value of more than 40. The quantity of emulsifiers and thickeners F) should preferably not exceed 10%, based on components A), B) and C).

Suitable emulsifiers are, in addition:

carboxymethylcellulose, hydrolysed starches, alginates, casein, hard paraffin and wax dispersions, dispersions based on copolymers of acrylic and methacrylic acid esters, butadiene and styrene, and/or polyvinyl alcohol (viscosity of the 4% aqueous solution at 20° C. at least 4 cP).

Polyvinyl alcohol in combination with sodium lauryl sulphate or alkyldimethylbenzylammonium chloride is particularly preferred.

Additives and auxiliary substances G) within the meaning of the invention are e.g. polysiloxane resins based on building blocks corresponding to the general formulae (I) and (II), fillers such as e.g. diatomaceous earths, finely dispersed quartz flour, amorphous silicas, pyrogenic and/or precipitated silicas with a BET surface of 50 to 500 m²/g. Fillers of this kind may be surface-modified e.g. with organosilicon compounds. The modification may also be achieved during incorporation in the polymer by the addition of e.g. hexamethyldisilazane or 1,3-divinyl-1,1,3,3-tetramethyldisilazane and water.

Additives and auxiliary substances G) within the meaning of the invention are also wetting agents which help to improve the wetting of the substrate with the emulsion. For example, polyether siloxanes (silicone surfactants) and/or fluorosurfactants are suitable for this purpose. Bacteriostatic agents (e.g. formaldehyde-cleaving products) may also be included amongst the additives and auxiliary substances G).

Component G) or the sum of components G) is preferably less than 5 wt. %, based on the weight of total mixture.

Demineralised or deionised water is preferred for the aqueous emulsion.

The aqueous emulsions according to the invention preferably have the following constituents:

| | |
|---|---|
| as component A): | T₈D₂₅₀M^{Vi}₇M₃ |
| as methyl hydrogen polysiloxane | M₂D^{H}₃₀D₁₀ |
| B): | |
| as organopolysiloxane C): | polydimethylsiloxane with a viscosity |
| | of 1 000 mm²/s |
| as catalyst D): | Pt-vinylsiloxane complex |
| as inhibitor E): | ethynyl cyclohexanol |
| as emulsifier and/or thickener F): | polyvinyl alcohol optionally in com- |
| | bination with sodium lauryl sulphate |
| as additives and/or auxiliary | bacteriostatic agents and/or polyether |
| substances G) | siloxane |

The invention also provides a process for the preparation of the emulsions according to the invention, according to which catalyst D) and optionally organopolysiloxane A) and/or organopolysiloxane C) are emulsified in water and an emulsion of organopolysiloxane A), methyl hydrogen polysiloxane B), organopolysiloxane C), inhibitor E), emulsifiers and/or thickener F) is prepared separately in water and the two emulsions are then stirred together.

Additional components G) may be added to the components A), B) and/or C) before emulsification or to one of the two emulsions after emulsification.

Suitable items of equipment for achieving a suitable particle size for the stability or emulsion are, e.g. high pressure homogenisers, colloid mills or the like.

If the molar ratio of SiH:Si vinyl provided for is taken into account when preparing the emulsions, both emulsions can be adjusted to a silicone content of 40% in such a way that they have to be mixed together prior to use in a quantity ratio of 1:1. It is also possible, however, to prepare an emulsion which contains only the catalyst D), emulsifiers and/or thickener F) and water, and which is added to a second emulsion of organopolysiloxane A), methyl hydrogen siloxane B), organosiloxane C), inhibitor E), emulsifiers and/or thickener F) and water in a quantity that is sufficient to bring about the desired catalytic effect.

The invention also provides for the use of the emulsions according to the invention for the preparation of an abhesive finish for flexible substrates.

Roller or knife applicators followed by a drying oven are suitable for this purpose.

The examples below serve to illustrate the invention without limiting its scope.

### EXAMPLES OF EXECUTION

### Example 1

| Component | Description | Quantity in wt. % |
|---|---|---|
| A) | T₈D₂₅₀M^{Vi}₇M₃ | 36.0 |
| B) | M₂D^{H}₃₀D₁₀ | 2.9 |
| C) | Polydimethylsiloxane with a | 1.0 |
| | viscosity of 1000 mm²/s | |
| | (Baysilone-Öl M 1000) | |
| E) | Ethynyl cyclohexanol | 0.1 |
| F) | Polyvinyl alcohol Mowiol 4-88 | 3.0 |
| | Sodium lauryl sulphate | 0.1 |
| G) | Bacteriostatic agent Preventol D2 | 0.1 |
| | from Bayer AG | |
| | Water | 56.8 |

### Preparation of Emulsion

Components F) were dissolved in distilled water at a temperature of 40° C. Components A), B), C), E) and G) were stirred together in a separate preparation vessel and then stirred as a mixture into the solution of component F) using a high-speed stirrer. The pre-emulsion thus obtained was homogenised in 5 passes at a pressure of 200 bar in a high-pressure homogeniser.

### Example 2

| Component | Description | Quantity in wt. % |
|---|---|---|
| A) | As in Example 1 | 32.7 |
| C) | As in Example 1 | 1.0 |
| D) | Pt-vinyl siloxane complex | 6.3 |
| | dissolved in polymer A with | |
| | 1320 ppm platinum | |
| F) | As in Example 1 | 3.0 + 0.1 |
| G) | As in Example 1 | 0.1 |
| | Water | 56.8 |

The emulsion was prepared as in Example 1, except with the above-mentioned components.

### Example 3

### Procedure for Coating Baking Paper

The emulsion components from Examples 1 and 2 were mixed in a ratio of 1:1 and diluted with water to approx. 10 wt. % active substance. This diluted emulsion mixture was applied to the paper to be coated and smoothed with a 10 mm metal knife. A similar procedure was followed on the other side of the paper. Drying took place afterwards in a hot cabinet at 160° C. and with a 15 sec. residence time. The silicone coating weight of the paper thus finished was then measured by x-ray fluorescence analysis. The coating weight in the case of the above-mentioned dilution was between 0.4 g and 0.6 g of silicone/m².

### Example 4

Baking test procedure

| | |
|---|---|
| Recipe: | 4 eggs |
| | 1.5 dl wheat flour |
| | 1 dl potato flour |
| | 1 dl sugar |
| | 1 teaspoon baking powder |

All the ingredients were processed at room temperature. Eggs and sugar were beaten until frothy in 5 min. with a universal kitchen machine on its highest speed setting, and the wheat flour, potato flour and baking powder were mixed together. The flour mixture was added through a sieve to the egg-sugar froth and stirred with a spoon. Before the dough was prepared, the coated paper was folded into moulds whose bases measured 15×20 cm. Four of these folded moulds were placed on a baking tin. The quantity of dough was then divided evenly between the four moulds. The dough was baked for 8 min. at 225° C. in a circulatory oven. The finished baked product was turned out and cooled for 2 min. at room temperature. The coated paper to be tested was then removed from the baked product.

Assessment: The quantity of baked product adhering to the paper, converted to g/m², was assessed. With the procedure according to Example 3, 20 g of adhering baked product/m² were found.

### Example 5

| Component | Description | Quantity in wt. % |
|---|---|---|
| A) | As in Example 1 | 37.6 |
| B) | As in Example 1 | 1.0 |
| C) | As in Example 1 | 1.0 |
| E) | As in Example 1 | 0.1 |
| F) | Polyvinyl alcohol Mowiol 4-88 | 3.0 |
| | Sodium lauryl sulphate | 0.1 |
| G) | Polyether siloxane as wetting | 0.3 |
| | agent (Baysilone Lackadditiv VP | |
| | AI 3468 from Bayer AG) | |
| | Preventol D2 | 0.1 |
| | Water | 56.8 |

### Example 6

| Component | Description | Quantity in wt. % |
|---|---|---|
| C) | As in Example 1 | 1.0 |
| D) | Pt-vinyl siloxane complex | 49.0 |
| | dissolved in polymer A with | |
| | 3400 ppm platinum | |
| F) | Mowiol 4-88 | 3.0 |
| | Sodium lauryl sulphate | 0.1 |
| G) | Preventol D2 | 0.1 |
| | Water | 46.8 |

### Example 7

### Procedure for Applying the Emulsion in the Laboratory

100 g of the emulsion from Example 5 and 3 g of the emulsion from Example 6 were diluted to 10% active substance; the subsequent procedure was the same as in Example 3.

### Example 8

### Baking Test Procedure

Using a similar procedure as in Example 4, 18 g of baked product residue/m² were found.

### Example 9

(Not According to the Invention)

Preparation of a 40% silicone emulsion in the same way as Example 1 without component C).

### Example 10

(Not According to the Invention)

Preparation of a 40% silicone emulsion in the same way as Example 2 without component C).

### Example 11

Emulsion 9 and 10 were mixed and applied in the same way as Example 3.

### Example 12

When the baking test was carried out in the same way as Example 4, but using the mixed emulsions of example 11, 100 g of baking residue/m² were found.

1. Aqueous emulsions consisting essentially of:
at least one organopolysiloxane A) containing at least 2 unsaturated hydrocarbon groups,
at least one methyl hydrogen polysiloxane B),
at least one unreactive organopolysiloxane C),
at least one catalyst D) from the platinum group,
at least one inhibitor E),
optionally, emulsifiers and/or thickeners F),
optionally, additives and/or auxiliary substances G).

2. Aqueous emulsions according to claim 1, wherein the organopolysiloxane A) containing at least 2 unsaturated hydrocarbon groups is a cyclic, linear or branched polysiloxane which contains units corresponding to the general formula (I)
(R)ₐ(R¹)_{b}SiO_{(4-a-b)/2} (I)
where
R=a C₂-C₈-alkenyl or an unsaturated C₃-C₁₀-ether radical and each R within one of said units of formula G) can be the same or different than any other R within said unit,
R¹=monovalent, saturated, optionally substituted hydrocarbon radicals with 1 to 10 carbon atoms from the group consisting substituted and unsubstituted alkyl, phenyl and phenylalkyl radicals,
wherein a and b are integers within the following limits: 0≦a≦3, 0≦b≦3 and 0≦a+b≦4 and each individual R and R¹ within the molecule may be the same or different.

3. Aqueous emulsions according to claim 1 or 2, wherein the organopolysiloxane A) containing at least 2 unsaturated hydrocarbon groups comprises diorganosiloxy units (D units) and triorganosiloxy units (M units) is branched and
the ratio of the number of diorganosiloxy units (D units) to the number of branching sites is on average 15 and 40,
at least one triorganosiloxy unit (M unit) and at most half of all the M units are free from unsaturated radicals, the remaining M units each bear only one unsaturated radical, and the content of unsaturated radicals is 0.05 to 10% .

4. Aqueous emulsions according to claim 1 or 2, wherein the methyl hydrogen polysiloxane B) contains units corresponding to the general formula
H_{c}(R²)_{d}SiO_{(4-c-d)/2} (II)
wherein R²=monovalent, saturated, optionally substituted hydrocarbon radicals with 1 to 10 carbon atoms selected from the group consisting of substituted and unsubstituted alkyl phenyl, phenylalkyl and/or C₂-C₈ alkenyl radicals, wherein
c and d are integers with 0≦d≦3 and 0≦c≦2 and 0≦c+d≦4.

5. Aqueous emulsions according to claim 1 or 2, wherein the methyl hydrogen polysiloxane B) is linear.

6. Aqueous emulsions according to claim 1 or 2, wherein in the methyl hydrogen polysiloxane B) the proportion of hydrogen atoms bound directly to a silicon atom is between 3 and 50 mmol per gram of the methyl hydrogen polysiloxane B).

7. Aqueous emulsions according to claim 1 to 2, wherein the components A) and B) are present in a quantity ratio such that the molar ratio of hydrogen atoms bound directly to a silicon atom (SiH) in component B) to the unsaturated radicals (Si-vinyl) in component A) is between 0.05 and 20.

8. Aqueous emulsions according to claim 1 or 2, wherein component C) is a polysiloxane containing units corresponding to the general formula (III)
(R¹)ₑSiO_{(4-e)/2} (III)
wherein R¹=monovalent, saturated, optionally substituted hydrocarbon radicals with 1 to 10 carbon atoms from the group consisting of substituted and unsubstituted alkyl, phenyl and phenylalkyl radicals which may be the same or different within the molecule, and e may be integers between 0 and 3.

9. Aqueous emulsions according to claim 1 or 2, wherein component D) is a catalyst which contains the elements platinum, rhodium, iridium, nickel, ruthenium [and/]or palladium in the elemental form or mixtures thereof, on a support substance, or in the form of their compounds.

10. Aqueous emulsions according to claim 1 or 2, wherein component E) is 2-methyl-3-butyn-2-ol, 1-ethynylcyclohexanol, (±) 3-phenyl-1-butyn-3-ol or mixture thereof.

11. Aqueous emulsions according to claim 1 or 2, wherein component F) is C₈-C₂₂-alkyldimethylbenzylammonium chloride, sodium lauryl sulphate, polyethylene glycol ethers of monohydric aliphatic alcohols C₁₂-C₂₀ and C₂-C₉-alkylphenols, polyethylene glycol esters of natural fatty acids C₈-C₂₂ and vegetable oils, partially acetylated polyvinyl alcohol with less than 20% acetyl groups and a K value of more than 40, or mixtures thereof.

12. Aqueous emulsions according to claim 1 or 2, wherein the additives and auxiliary substances G) are
polysiloxane resins based on building blocks corresponding to the general formulae (I) and (II),
fillers, flow promoters, polyether siloxanes, fluorosurfactants, bacteriostatic agents or combinations thereof.

13. Aqueous emulsions according to claim 1 or 2, comprising:

| | |
|---|---|
| as component A): | T₈D₂₅₀M^{Vi}₇M₃ |
| as methyl hydrogen polysiloxane B): | M₂D^{H}₃₀D₁₀ |
| as organopolysiloxane C): | polydimethylsiloxane with a |
| | viscosity of 1 000 mm²/s |
| as catalyst D): | Pt-vinylsiloxane complex |
| as inhibitor E): | ethynyl cyclohexanol |
| as stabiliser and/or thickener F): | polyvinyl alcohol optionally in |
| | combination with sodium lauryl |
| | sulphate |
| as additives and/or auxiliary | bacteriostatic agents and/or |
| substances G) | polyether siloxane. |

14. A process for the preparation of aqueous emulsions according to claim 1 or 2, wherein catalyst D) and optionally organopolysiloxane A) or organopolysiloxane or both are emulsified in water and an emulsion of organopolysiloxane A), methyl hydrogen polysiloxane B), organopolysiloxane C), inhibitor E), optionally emulsifiers and/or thickener F) is prepared separately in water, and both emulsions are then stirred together.

15. An abhesive finish for flexible substrates comprising an emulsion according to claim 1.

16. A coated flexible substrate having a coating formed by applying the emulsion of claim 1 to the substrate, and then drying.
